(19) United States
(12) Patent Application Publication
(10) Pub. No.: US 2023/0417959 A1
(43) Pub. Date: Dec. 28, 2023

(54) VIEWING ANGLE CONTROL FILM

(71) Applicant: LINTEC CORPORATION, Tokyo (JP)

(72) Inventors: Tatsuki KURAMOTO, Tokyo (JP); Hiroki FUKUSHIMA, Tokyo (JP); Baku KATAGIRI, Tokyo (JP); Kentaro KUSAMA, Tokyo (JP)

(73) Assignee: LINTEC CORPORATION, Tokyo (JP)

(21) Appl. No.: 18/127,733

(22) Filed: Mar. 29, 2023

(30) Foreign Application Priority Data
Mar. 30, 2022 (JP) 2022-056905

(51) Int. Cl. G02B 5/02

(52) U.S. Cl. CPC G02B 5/0236

(57) ABSTRACT

A viewing angle control film having an incident light diffusion angle region, wherein when the viewing angle control film is installed vertically to a ground surface, the incident light diffusion angle region in an up-down direction does not include a front face 0° in a horizontal direction with respect to the ground surface, and a total luminous transmittance at the front face 0° is 85% or more and 100% or less. The viewing angle control film preferably has a louver-shaped internal structure including a plurality of regions having a relatively high refractive index (plate-like high refractive index regions) in a region having a relatively low refractive index (low refractive index region).

### TECHNICAL FIELD

The present invention relates to a viewing angle control film.

### BACKGROUND ART

In recent years, light-emitting display devices (displays) are often used in car navigation systems and various meters such as speedometers in automobiles and the like.

In general, in-vehicle displays such as those described above are commonly used near the windshield or a side window of automobiles. At night, therefore, the light from the display is reflected on the windshield or side window, which may impair safety. In addition, if the display is installed in front of the front passenger seat, when the person in the front passenger seat watches a movie or TV on the display, the driver in the driver seat may also be able to see it, which may impair safety also from such a viewpoint.

To solve the above problems, it is conceivable to install a light-shielding hood for the display, but this may cause a design problem. It is also possible to provide the display with a security/privacy filter (available from 3M Company, for example), but this may cause a problem in that the front face luminance of the display deteriorates.

Patent Document 1 discloses a display device in which the viewing angle and luminance are contemplated, but this display device is basically intended to improve the problem of color change.

### PRIOR ART DOCUMENTS

### Patent Documents

[Patent Document 1] JP2014-115421A

### SUMMARY OF THE INVENTION

### Problems to be Solved by the Invention

The present invention has been made in consideration of the actual circumstances as above, and an object of the present invention is to provide a viewing angle control film capable of controlling the viewing angle while suppressing the deterioration in the front face luminance.

### Means for Solving the Problems

To achieve the above object, first, the present invention provides a viewing angle control film having an incident light diffusion angle region, wherein when the viewing angle control film is installed vertically to a ground surface, the incident light diffusion angle region in an up-down direction does not include a front face 0° in a horizontal direction with respect to the ground surface, and a total luminous transmittance at the front face 0° is 85% or more and 100% or less (Invention 1).

The viewing angle control film according to the above invention (Invention 1) has the incident light diffusion angle region and can thereby control the viewing angle. That is, when the viewing angle control film is provided for a light-emitting display device (display), control is possible such that the light from the display easily transmits through the film at a predetermined angle and is less likely to transmit through the film at another angle. Moreover, the above viewing angle control film is configured such that the incident light diffusion angle region does not include the above front face 0° and the total luminous transmittance at the above front face 0° falls within the above range, and can thereby suppress the deterioration in the front face luminance. Therefore, the image on a display provided with the viewing angle control film is easy to see from the front.

In the above invention (Invention 1), a haze value at the front face 0° may be preferably 0% or more and 40% or less (Invention 2).

In the above invention (Invention 1, 2), a sum of image clarity values of 0.125 mm, 0.25 mm, 0.5 mm, 1.0 mm, and 2.0 mm optical combs measured in accordance with JIS K7374: 2007 may be preferably 350 or more (Invention 3).

In the above invention (Invention 1 to 3), the viewing angle control film may preferably have a thickness of 50 μm or more and 450 μm or less (Invention 4).

In the above invention (Invention 1 to 4), provided that L0 represents a luminance measured when the viewing angle control film is not present between a given light source and a luminance measuring device and L1 represents a luminance measured when the viewing angle control film is present between the light source and the luminance measuring device, a luminance change rate (%) represented by Formula (1) below is:
85% or more at the front face 0° of the viewing angle control film; and
95% or less at −10° (a positive angle is defined in a direction of rotation in which a traveling direction side in a carrying direction when manufacturing the viewing angle control film approaches the light source) from a central angle of the incident light diffusion angle region of the viewing angle control film (Invention 5).

Luminance change rate (%)=(L1/L0)×100 (1)

In the above invention (Invention 1 to 5), the viewing angle control film has a louver-shaped internal structure comprising a plurality of regions having a relatively high refractive index in a region having a relatively low refractive index, and the louver-shaped internal structure is provided so that a longitudinal direction of the louver-shaped internal structure extends horizontally when the viewing angle control film is installed vertically to the ground surface (Invention 6).

### Advantageous Effect of the Invention

According to the viewing angle control film of the present invention, it is possible to control the viewing angle while suppressing the deterioration in the front face luminance.

### BRIEF DESCRIPTION OF DRAWING(S)

FIG. 1 is a schematic perspective view of a viewing angle control film according to an embodiment of the present invention.

### EMBODIMENTS FOR CARRYING OUT THE INVENTION

Hereinafter, one or more embodiments of the present invention will be described.

The viewing angle control film according to an embodiment of the present invention has an incident light diffusion angle region. When the viewing angle control film is installed vertically to the ground surface, the incident light diffusion angle region in the up-down direction preferably does not include a front face 0° in the horizontal direction with respect to the ground surface. In addition, the total luminous transmittance at the above front face 0° of the viewing angle control film according to the present embodiment is preferably 85% or more and 100% or less.

As used in the present specification, the “incident light diffusion angle region” refers to an angle range in which the haze value is 80% or more when the haze value is measured by changing the incident angle of the measurement light to the viewing angle control film.

The viewing angle control film according to the present embodiment having the above configuration has the incident light diffusion angle region and can thereby control the viewing angle. That is, when the viewing angle control film according to the present embodiment is provided for a light-emitting display device (display) (being provided for includes the concept of being attached to), control is possible such that the light from the display easily transmits through the film at a predetermined angle and is less likely to transmit through the film at another angle. According to this, for example, when the viewing angle control film of the present embodiment is provided for an in-vehicle display, it is possible to suppress the reflection of light from the display on the windshield or a side window at night. Moreover, if the viewing angle control film according to the present embodiment is provided on the screen of a display installed in front of the front passenger seat, the light and images (including the concept of video) of the display can be made less visible to the driver in the driver seat.

Furthermore, the viewing angle control film according to the present embodiment is configured as above such that the incident light diffusion angle region does not include the above front face 0° and the total luminous transmittance at the above front face 0° falls within the above range, and can thereby suppress the deterioration in the front face luminance. Therefore, the image on a display provided with the viewing angle control film according to the present embodiment is easy to see from the front.

From the viewpoint of front face luminance, the total luminous transmittance at the front face 0° of the viewing angle control film according to the present embodiment may be preferably 85% or more, more preferably 87% or more, particularly preferably 89% or more, and further preferably 90% or more. The upper limit of the above total luminous transmittance is not particularly limited, and may be 100%, but in order to obtain a desired incident light diffusion angle region, the upper limit may be preferably 99% or less, particularly preferably 95% or less, and further preferably 92% or less. A specific method of measuring the total luminous transmittance at the front face 0° is as described in the testing example, which will be described later.

The upper limit (end angle) of the incident light diffusion angle region of the viewing angle control film in the present embodiment may be preferably −1° or less, more preferably −5° or less, particularly preferably −10° or less, and further preferably −15° or less. On the other hand, the lower limit (start angle) of the incident light diffusion angle region may be preferably close to −60° and may exceed −60° . Provided that the incident light diffusion angle region of the viewing angle control film falls within the above range, when the viewing angle control film according to the present embodiment is installed vertically to the ground surface, the above incident light diffusion angle region in the up-down direction can be set so as not to include the front face 0° in the horizontal direction with respect to the ground surface. A method of measuring the incident light diffusion angle region in the present specification is as described in the testing example, which will be described later.

The haze value at the front face 0° of the viewing angle control film in the present embodiment may be preferably 0% to 40%, more preferably 0% to 30%, particularly preferably 0% to 20%, and further preferably 0% to 15%. When the haze value at the front face 0° falls within the above range, it is possible to easily control the above-described viewing angle and maintain a higher front face luminance. A specific method of measuring the haze value at the front face 0° is as described in the testing example, which will be described later.

In the viewing angle control film in the present embodiment, the sum of image clarity values (%) of 0.125 mm, 0.25 mm, 0.5 mm, 1.0 mm, and 2.0 mm optical combs measured in accordance with JIS K7374: 2007 may be preferably 350 or more, more preferably 400 or more, particularly preferably 430 or more, further preferably 442 or more, especially preferably 450 or more, and most preferably 470 or more. This can suppress the image blur in a display provided with the viewing angle control film in the present embodiment, and the image visibility can be satisfactory.

The upper limit of the above sum of image clarity values (%) is not particularly limited, but from the viewpoint of the above-described viewing angle control, the upper limit may be preferably 500 or less, more preferably 495 or less, particularly preferably 485 or less, and further preferably 480 or less.

Here, the image clarity is obtained by transmitting parallel light rays through a specimen and measuring the light amount of the parallel light rays through an optical comb having transmission portions and light shielding portions. The smaller the width (comb width) between the transmission portions and the light shielding portions in the optical comb, the higher definition the image clarity represents. The image clarity is measured in accordance with the transmission method of JIS K7374: 2007. A specific measuring method is as described in the testing example, which will be described later.

In the viewing angle control film in the present embodiment, provided that L0 represents a luminance measured when the viewing angle control film is not present between a given light source and a luminance measuring device and L1 represents a luminance measured when the viewing angle control film is present between the light source and the luminance measuring device, a luminance change rate (%) represented by Formula (1) below may be preferably 85% or more at the front face 0° of the viewing angle control film and may also be preferably 95% or less at −10° (the positive angle is defined in a direction of rotation in which the traveling direction side in a carrying direction when manufacturing the viewing angle control film approaches the light source) from the central angle of the incident light diffusion angle region of the viewing angle control film. Here, the “central angle of the incident light diffusion angle region” refers to the central angle between the start angle and the end angle of the incident light diffusion angle region. A specific method of measuring the above luminance is as described in the testing example, which will be described later.

Luminance change rate (%)=(L1/L0)×100 (1)

When the above luminance change rate at the front face 0° is the above value, it can be said that the front face luminance is maintained high. From this viewpoint, the luminance change rate at the front face 0° may be preferably 85% or more, more preferably 90% or more, particularly preferably 95% or more, further preferably 97% or more, especially preferably 99% or more, and most preferably 99.9% or more. The upper limit of the above luminance change rate at the front face 0° is not particularly limited and may be 100%.

On the other hand, when the luminance change rate at −10° from the central angle of the incident light diffusion angle region is the above value, the light from a display is less likely to transmit through the viewing angle control film at a predetermined angle, and the display can be dark at that angle; therefore, it can be said that the viewing angle is well controlled. From this viewpoint, the luminance change rate at −10° from the central angle of the incident light diffusion angle region may be preferably 95% or less, more preferably 90% or less, particularly preferably 88% or less, and further preferably 80% or less. The lower limit of the above luminance change rate at −10° from the central angle of the incident light diffusion angle region is not particularly limited and may be 0%, but from the viewpoint of achieving both the above properties and the desired optical properties (image clarity, haze value, total luminous transmittance, etc.), the lower limit may be preferably 10% or more, particularly preferably 30% or more, and further preferably 50% or more.

To exhibit the previously described physical properties, the viewing angle control film according to the present embodiment may preferably have a louver-shaped internal structure (louver structure) that includes a plurality of regions having a relatively high refractive index in a region having a relatively low refractive index.

When the viewing angle control film according to the present embodiment is provided for a display, the viewing angle control film may be installed such that the longitudinal direction of the above louver structure extends in the horizontal direction or in the vertical direction or may also be installed such that the longitudinal direction of the above louver structure extends at a desired angle. The form of installation may be appropriately selected depending on the purpose of viewing angle control.

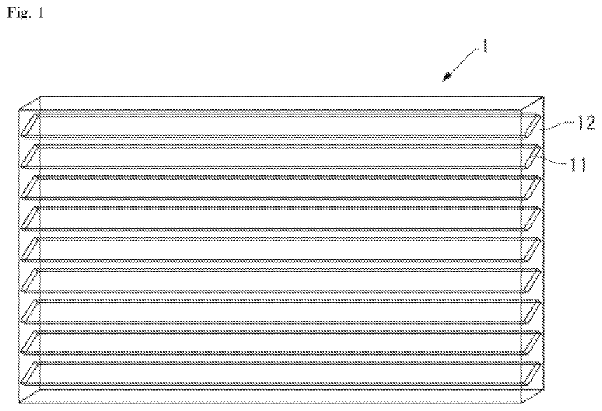

FIG. 1 illustrates a schematic perspective view of a viewing angle control film 1 according to an embodiment of the present invention.

### 1. Structure of Viewing Angle Control Film

The viewing angle control film 1 according to the present embodiment has a structure as the louver structure in which a plurality of plate-like high refractive index regions 11 having a relatively high refractive index is arranged in parallel at predetermined intervals and the spaces between the plate-like high refractive index regions 11 are filled with a low refractive index region 12 having a relatively low refractive index. In the viewing angle control film 1 illustrated in FIG. 1, the louver structure is formed such that when the viewing angle control film 1 is installed vertically to the ground surface, the longitudinal direction of the above plate-like high refractive index regions 11 extends horizontally, but the present invention is not limited to this.

The light incident on the viewing angle control film 1 having the louver structure as above is likely to be diffused to spread in a direction (short-side direction) perpendicular to the longitudinal direction of the plate-like high refractive index regions 11, and the incident light diffusion angle region is thereby determined. The plate-like high refractive index regions 11 in the present embodiment are arranged to be tilted with respect to the plane of the viewing angle control film 1, and this angle is appropriately adjusted so as to satisfy the previously described physical properties. In the present embodiment, an angle on the acute angle side formed between one surface of each plate-like high refractive region 11 and the normal line of the light diffusion control 1 film may be preferably 5° to 42°, more preferably 10° to 41.5°, particularly preferably 15° to 41°, and further preferably 30° to 40°.

In the above louver structure, the thickness (width in the arrangement direction) of each plate-like high refractive index region 11 may be preferably 0.1 to 10 μm, particularly preferably 0.5 to 8 μm, and further preferably 1 to 5 μm. The interval between adjacent plate-like high refractive index regions 11 may be preferably 0.1 to 10 μm, particularly preferably 0.5 to 8 μm, and further preferably 1 to 5 μm.

FIG. 1 depicts the plate-like high refractive index regions 11 as existing in the entire thickness direction of the viewing angle control film 1, but the plate-like high refractive index regions 11 may not exist at least in one of end portions of the viewing angle control film 1 in the thickness direction. Here, the ratio of the plate-like high refractive index regions 11 extending in the thickness direction of the viewing angle control film 1 may be preferably 10% or more, more preferably 30% or more, and particularly preferably 50% or more from the viewpoint of making the light diffusivity more efficient. The upper limit of the ratio is not limited and may be 100%, that is, the internal structure may be formed in the entire thickness direction of the viewing angle control film 1.

In the above louver structure, the difference between the refractive index of the plate-like high refractive regions 11 having a relatively high refractive index and the refractive index of the low refractive index region 12 having a relatively low refractive index may be preferably 0.01 to 0.3, particularly preferably 0.05 to 0.25, and further preferably 0.1 to 0.2.

In the louver structure in the present embodiment, the plate-like high refractive index regions 11 have a planar shape, but may have a shape in which the plate-like high refractive index regions 11 are bent at the middle in the thickness direction of the viewing angle control film 1. Additionally or alternatively, the louver structure in the present embodiment may be a structure in which the plate-like high refractive index regions 11 are each provided as two or more portions in the thickness direction of the viewing angle control film 1 so as to have different tilt angles, different bending angles, or difference in the presence or absence of bending.

The dimensions, angles, and other parameters relating to the internal structure of the louver structure described above can be measured by observing the cross section of the louver structure using an optical digital microscope.

The thickness of the viewing angle control film 1 in the present embodiment may be preferably 50 to 450 μm, particularly preferably 60 to 400 μm, further preferably 70 to 300 μm, and also preferably 80 to 250 μm. When the thickness of the viewing angle control film 1 falls within the above range, the previously described physical properties can be readily exhibited.

### 2. Materials

The viewing angle control film 1 in the present embodiment may be preferably obtained from a composition that contains a high refractive index component and a low refractive index component having a refractive index lower than that of the high refractive index component (this composition will be referred to as a “light diffusion control composition C,” hereinafter). In particular, the viewing angle control film 1 according to the present embodiment may be preferably obtained by curing the above light diffusion control composition C, and in this case, each of the high refractive index component and the low refractive index component may preferably have one or two polymerizable functional groups. The use of such a light diffusion control composition C allows the previously described louver structure to be readily and satisfactorily formed.

The following description will be made for a case in which the light diffusion control composition C contains a high refractive index component and a low refractive index component having a refractive index lower than that of the high refractive index component and each of the high refractive index component and the low refractive index component has one or two polymerizable functional groups, but the present invention is not limited to this.

### (1) High Refractive Index Component

Preferred examples of the above high refractive index component include (meth)acrylic ester that contains an aromatic ring, and (meth)acrylic ester that contains a plurality of aromatic rings may be particularly preferred. Examples of the (meth)acrylic ester that contains a plurality of aromatic rings include those in which a part thereof is substituted with halogen, alkyl, alkoxy, alkyl halide, or the like, such as biphenyl (meth)acrylate, naphthyl (meth)acrylate, anthracyl (meth)acrylate, benzylphenyl (meth) acrylate, biphenyloxyalkyl (meth) acrylate, naphthyloxyalkyl (meth) acrylate, anthracyloxyalkyl (meth)acrylate, and benzylphenyloxyalkyl (meth)acrylate. Among these, biphenyl (meth)acrylate may be preferred from the viewpoint of readily forming a satisfactory regular internal structure. Specifically, o-phenylphenoxyethyl acrylate, o-phenylphenoxyethoxyethyl acrylate, and the like may be preferred. In the present specification, (meth)acrylic acid means both the acrylic acid and the methacrylic acid. The same applies to other similar terms.

The molecular weight (weight-average molecular weight) of the high refractive index component may be preferably 150 to 2,500, particularly preferably 200 to 2,000, and further preferably 250 to 1,000. When the molecular weight (weight-average molecular weight) of the high refractive index component falls within the above range, the viewing angle control film 1 having a desired louver structure can be readily formed. When the theoretical molecular weight of the above high refractive index component can be specified based on the molecular structure, the molecular weight (weight-average molecular weight) of the high refractive index component refers to the theoretical molecular weight (molecular weight that may not be the weight-average molecular weight). On the other hand, when it is difficult to specify the above-described theoretical molecular weight, for example, due to the above high refractive index component being a polymer component, the molecular weight (weight-average molecular weight) of the high refractive index component refers to a weight-average molecular weight obtained as a standard polystyrene-equivalent value that is measured using a gel permeation chromatography (GPC) method. As used in the present specification, the weight-average molecular weight refers to a value that is measured as the standard polystyrene equivalent value using the GPC method.

The refractive index of the high refractive index component may be preferably 1.45 to 1.70, more preferably 1.50 to 1.68, particularly preferably 1.54 to 1.65, and further preferably 1.54 to 1.59. When the refractive index of the high refractive index component falls within the above range, the viewing angle control film 1 having a desired regular internal structure and desired light diffusion control ability can be readily formed. As used in the present specification, the refractive index means the refractive index of a certain component before curing the light diffusion control composition C, and the refractive index is measured in accordance with JIS K0062: 1992.

The content of the high refractive index component in the light diffusion control composition C may be preferably 25 to 400 mass parts, particularly preferably 40 to 300 mass parts, and further preferably 50 to 200 mass parts with respect to 100 mass parts of the low refractive index component. When the content of the high refractive index component falls within such ranges, the regions derived from the high refractive index component and the region derived from the low refractive index component exist with a desired ratio in the louver structure of the viewing angle control film 1 formed. As a result, the viewing angle control film 1 having a desired louver structure can be readily formed.

### (2) Low Refractive Index Component

Preferred examples of the above low refractive index component include urethane (meth)acrylate, a (meth)acrylic-based polymer having a (meth)acryloyl group in a side chain, a (meth)acryloyl group-containing silicone resin, and an unsaturated polyester resin, but it may be particularly preferred to use urethane (meth)acrylate.

The above urethane (meth)acrylate may be preferably formed of (a) a compound that contains at least two isocyanate groups, (b) polyalkylene glycol, and (c) hydroxyalkyl (meth) acrylate.

Preferred examples of the above (a) compound that contains at least two isocyanate groups include aromatic polyisocyanates such as 2,4-tolylene diisocyanate, 2,6-tolylene diisocyanate, 1,3-xylylene diisocyanate, and 1,4-xylylene diisocyanate, aliphatic polyisocyanates such as hexamethylene diisocyanate, alicyclic polyisocyanates such as isophorone diisocyanate (IPDI) and hydrogenated diphenylmethane diisocyanate, biuret bodies and isocyanurate bodies thereof, and adduct bodies (e.g., a xylylene diisocyanate-based trifunctional adduct body) that are reaction products with low molecular active hydrogen-containing compounds such as ethylene glycol, propylene glycol, neopentyl glycol, trimethylol propane, and castor oil. Among these, an alicyclic polyisocyanate may be preferred, and an alicyclic diisocyanate that contains only two isocyanate groups may be particularly preferred.

Preferred examples of the above (b) polyalkylene glycol include polyethylene glycol, polypropylene glycol, polybutylene glycol, and polyhexylene glycol, among which polypropylene glycol may be preferred.

The weight-average molecular weight of the above (b) polyalkylene glycol may be preferably 2,300 to 19,500, particularly preferably 3,000 to 14,300, and further preferably 4,000 to 12,300.

Preferred examples of the above (c) hydroxyalkyl (meth)acrylate include 2-hydroxyethyl (meth)acrylate, 2-hydroxypropyl (meth) acrylate, 3-hydroxypropyl (meth)acrylate, 2-hydroxybutyl (meth)acrylate, 3-hydroxybutyl (meth) acrylate, and 4-hydroxybutyl (meth) acrylate.

Synthesis of the urethane (meth)acrylate using the above-described components (a) to (c) as the materials can be performed in a commonly-used method. In such a method, from the viewpoint of efficiently synthesizing the urethane (meth) acrylate, the compounding ratio of the components (a), (b), and (c) as the molar ratio may be preferably set to a ratio of 1-5:1:1-5 and particularly preferably set to a ratio of 1-3:1:1-3.

The weight-average molecular weight of the low refractive index component may be preferably 3,000 to 20,000, particularly preferably 5,000 to 15,000, and further preferably 7,000 to 13,000. When the weight-average molecular weight of the low refractive index component falls within the above range, the viewing angle control film 1 having a desired louver structure and desired light diffusion control ability can be readily formed.

The refractive index of the low refractive index component may be preferably 1.30 to 1.59, more preferably 1.35 to 1.50, particularly preferably 1.40 to 1.49, and further preferably 1.46 to 1.48. When the refractive index of the low refractive index component falls within the above range, the viewing angle control film 1 having a desired louver structure and desired light diffusion control ability can be readily formed.

### (3) Other Components

The previously described light diffusion control composition C may contain other additives in addition to the high refractive index component and the low refractive index component. Examples of the other additives include a polyfunctional monomer (compound having three or more polymerizable functional groups), a photopolymerization initiator, an ultraviolet absorber, a light stabilizer, a leveling agent, an antioxidant, an antistatic, a polymerization accelerator, a polymerization inhibitor, an infrared absorber, a plasticizer, and a diluting solvent.

Among the above-described additives, a photopolymerization initiator may be preferably contained in the light diffusion control composition C. When the light diffusion control composition C contains a photopolymerization initiator, the viewing angle control film having a desired regular internal structure can be readily and efficiently formed.

Examples of the photopolymerization initiator include benzoin, benzoin methyl ether, benzoin ethyl ether, benzoin isopropyl ether, benzoin-n-butyl ether, benzoin isobutyl ether, acetophenone, dimethylaminoacetophenone, 2,2-dimethoxy-2-phenylacetophenone, 2,2-diethoxy-2-phenylacetophenone, 2-hydroxy-2-methyl-1-phenylpropan-1-one, 1-hydroxycyclohexyl phenyl ketone, 2-methyl-1-[4-(methylthio)phenyl]-2-morpholino-propan-1-one, 4-(2-hydroxyethoxy)phenyl-2-(hydroxy-2-propyl)ketone, benzophenone, p-phenylbenzophenone, 4,4-diethylaminobenzophenone, dichlorobenzophenone, 2-methylanthraquinone, 2-ethylanthraquinone, 2-tert-butylanthraquinone, 2-aminoanthraquinone, 2-methylthioxanthone, 2-ethylthioxanthone, 2-chlorothioxanthone, 2,4-dimethylthioxanthone, 2,4-5 diethylthioxanthone, benzyl dimethyl ketal, acetophenone dimethyl ketal, p-dimethylaminebenzoic ester, and oligo[2-hydroxy-2-methyl-1-[4-(1-methylvinyl)phenyl]propane]. These may each be used alone or two or more types may also be used in combination.

When the photopolymerization initiator is used, it may be preferred to set the content of the photopolymerization initiator in the light diffusion control composition C preferably to 0.2 to 20 mass parts, particularly preferably to 0.5 to 15 mass parts, and further preferably to 1 to 10 mass parts with respect to 100 mass parts of the total amount of the high refractive index component and the low refractive index component. By setting the content of the photopolymerization initiator in the light diffusion control composition C within the above range, the viewing angle control film 1 can be readily and efficiently formed.

The light diffusion control composition C may also preferably contain an ultraviolet absorber, and this can suppress the liquefaction of the viewing angle control film 1 and can improve the weather resistance.

Examples of the ultraviolet absorber include benzophenone-based compounds, benzotriazole-based compounds, triazine-based compounds, cyanoacrylates, and salicylic esters, and one type may be used alone or two or more types may be used in combination. Among the above, the benzophenone-based compounds, benzotriazole-based compounds, or triazine-based compounds may be preferred, and the benzotriazole-based compounds may be particularly preferred. These compounds have good compatibility with the previously described high refractive index component and low refractive index component and also have a low degree of coloring.

Preferred examples of the benzophenone-based compounds include 2,2-dihydroxy-4-methoxybenzophenone, 2,4-dihydroxybenzophenone, 2-hydroxy-4-methoxybenzophenone, 2-hydroxy-4-methoxybenzophenone-5-sulfonic acid hydrate, and 2-hydroxy-4-n-octyloxybenzophenone. Preferred examples of the benzotriazole-based compounds include 2-(2-hydroxy-5-t-butylphenyl)-2H-benzotriazole, octyl-3-[3-t-butyl-4-hydroxy-5-(5-chloro-2H-benzotriazole-2-yl]phenyl) propionate, 2-ethylhexyl-3-[3-t-butyl-4-hydroxy-5-(5-chloro-2H-benzotriazole-2-yl]phenyl) propionate, and benzenepropanoic acid-3-(2H-benzotriazole-2-yl)-5-(1,1-dimethylethyl)-4-hydroxy-alkyl ester. Preferred examples of the triazine-based compounds include 2,4-bis[2-hydroxy-4-butoxyphenyl]-6-(2,4-dibutoxyphenyl)-1,3-5-triazine and 2-[4,6-di(2,4-xylyl)-1,3,5-triazine-2-yl]-5-octyloxyphenol. These may each be used alone or two or more types may also be used in combination.

When an ultraviolet absorber is used, the content of the ultraviolet absorber in the light diffusion control composition C may be preferably 0.001 to 5 mass %, more preferably 0.01 to 1 mass %, particularly preferably 0.02 to 0.5 mass %, and further preferably 0.06 to 0.1 mass %. When the content of the ultraviolet absorber falls within the above range, the effect of suppressing the liquefaction of the viewing angle control film 1 can be more excellent without inhibiting the ultraviolet curing of the light diffusion control composition C.

The light diffusion control composition C may also preferably contain a light stabilizer. In this case, it may be particularly preferred to contain a light stabilizer capable of suppressing the liquefaction and yellowing of the viewing angle control film 1.

A weakly basic hindered amine-based compound having a carbonate skeleton (this compound may be referred to as a “hindered amine-based compound CL,” hereinafter) may be preferred as the light stabilizer as above. When the light diffusion control composition C contains the hindered amine compound CL, the liquefaction and yellowing of the viewing angle control film 1 can be suppressed even if it is used over time in an environment exposed to external light.

The liquefaction and yellowing of a film in which the light diffusion control composition C is used are mainly caused by the generation of active oxygen or radicals, and in particular, occur such that the generation of active oxygen or radicals breaks the ether bonds of the resin to reduce its molecular weight. According to the hindered amine-based compound CL, the hindered amine skeleton can trap the active oxygen and radicals, and the carbonate skeleton can suppress the breakage of ether bonds. Furthermore, the hindered amine-based compound CL is weakly basic, so that deactivation by acid does not occur. Due to these actions, the hindered amine-based compound CL can sustainably capture the generated active oxygen and radicals and suppress the liquefaction and yellowing of the viewing angle control film 1 due to the use over time.

The hindered amine refers to an amine that has bulky substituents on both sides of an amino group. As used in the present specification, being “weakly basic” refers to relatively weak or low basicity and is distinguished from ordinary “basicity.” Specifically, the relatively weak or low basicity refers to a base dissociation constant (pKb) that is preferably 6 or more, more preferably 8 or more, particularly preferably 10 or more, and further preferably 11 or more in water at 1 atm and 25° C.

The hindered amine-based compound CL may be preferably a compound that includes at least one skeleton represented by the following general formula (I).

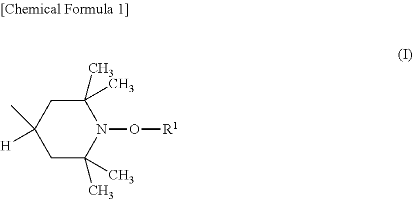

The hindered amine-based compound CL having the above structure is excellent in the effects of suppressing the liquefaction and yellowing of the viewing angle control film 1. Moreover, the hindered amine-based compound CL has an N—O—R′ skeleton thereby to well exhibit the weak or low basicity, and the previously described effects are more excellent. It is to be noted that a hindered amine-based compound having an N-alkyl group skeleton, in particular an N—CH₃ skeleton, rather than the N—O—R′ skeleton, exhibits basicity.

In the hindered amine-based compound CL, R¹ in the above general formula (I) may be preferably an alkyl group. The carbon number of the alkyl group may be preferably 1 to 30, more preferably 3 to 25, particularly preferably 7 to 18, and further preferably 9 to 13. When R¹ is an alkyl group, preferred weak or low basicity is exhibited, and when the carbon number of the alkyl group is within the above range, more preferred weak or low basicity is exhibited.

The hindered amine-based compound CL may preferably have one or more skeletons represented by the above general formula (I), more preferably have two to ten skeletons, particularly preferably have two to seven skeletons, further preferably have two to four skeletons, and most preferably have two skeletons. The one or more skeletons represented by the above general formula (I) may be present at one or more terminals of the hindered amine-based compound, at one or more side chains, or at one or more terminals and one or more side chains.

When the hindered amine-based compound has two or more skeletons represented by the above general formula (I), each R¹ may be the same or may also be different.

The hindered amine-based compound CL has a carbonate skeleton (—O—C(═O)—O—) at any position, but preferably, a terminal oxygen atom of the carbonate skeleton may be bonded to the 4-position carbon atom in the skeleton represented by the above general formula (I). By having a carbonate skeleton at this position, the hindered amine-based compound CL is more excellent in the effects of suppressing the liquefaction and yellowing of the viewing angle control film 1.

The hindered amine-based compound CL may be particularly preferably a compound that is represented by the following structural formula (A).

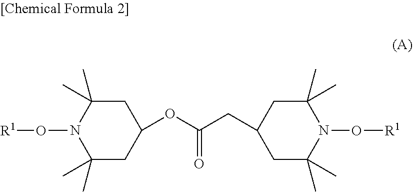

Each R¹ in the compound represented by the above structural formula (A) is the same as R¹ in the skeleton represented by the above-described general formula (I). Two R¹s in the above structural formula (A) may be the same or different, but are preferably the same.

When a light stabilizer is used, the content of the light stabilizer (in particular, the hindered amine-based compound CL) in the light diffusion control composition C may be preferably 0.01 to 10 mass %, more preferably 0.1 to 8 mass %, particularly preferably 0.3 to 5 mass %, further preferably 0.5 to 3 mass %, and most preferably 0.8 to 2 mass %. When the content of the light stabilizer falls within the above range, the effects of suppressing the liquefaction and yellowing of the viewing angle control film 1 are more excellent, and the incident light diffusion angle region of the viewing angle control film 1 obtained can be readily set within a desired range

The light diffusion control composition C may also preferably contain a leveling agent, and this can improve the surface smoothness of the viewing angle control film 1 obtained. Examples of the leveling agent include silicone-based leveling agents, fluorine-based leveling agents, acrylic-based leveling agents, siloxane-modified acrylic-based leveling agents, and vinyl-based leveling agents. In the light diffusion control composition C, it may be preferred to use an acrylic-based leveling agent from the viewpoint of compatibility and handling ability.

Examples of commercially available acrylic-based leveling agents include BYK-350, BYK-352, BYK-354, BYK-355, BYK-358N, BYK-361N, BYK-380N, BYK-381, and BYK-392 available from BYK JAPAN KK.

When a leveling agent is used, the content of the leveling agent in the light diffusion control composition C may be preferably 0.1 to 5 mass %, more preferably 0.15 to 3 mass %, particularly preferably 0.2 to 2 mass %, and further preferably 0.3 to 1 mass %. When the content of the leveling agent falls within the above range, the surface smoothness of the viewing angle control film 1 can be more excellent.

### 3. Method of Manufacturing

The method of manufacturing the viewing angle control film according to the present embodiment is not particularly limited, and the viewing angle control film can be manufactured using a conventionally known method. For example, the previously described composition for viewing angle control films, preferably the light diffusion control composition C, may be prepared, and one surface of a process sheet may be coated with the composition to form a coating film. Preferably, the viewing angle control film can be formed by irradiating the above coating film with active energy rays to cure the coating film. Before or after the above irradiation with active energy rays, one surface (in particular, release surface) of a release sheet may be attached to the surface of the above coating film opposite to the process sheet, and the above coating film may be cured by irradiating the coating film with active energy rays through the process sheet or the release sheet.

The light diffusion control composition C can be prepared by uniformly mixing the previously described high refractive index component and low refractive index component and, if desired, other additives such as a photopolymerization initiator.

In the above mixing, a uniform light diffusion control composition C may be obtained by stirring it while heating it to a temperature of 40° C. to 80° C. A diluting solvent may be added and mixed so that the obtained light diffusion control composition C has a desired viscosity.

Examples of the method for the above coating include a knife coating method, a roll coating method, a bar coating method, a blade coating method, a die coating method, and a gravure coating method. The light diffusion control composition C may be diluted using a solvent as necessary.

The above active energy rays refer to electromagnetic wave or charged particle radiation having an energy quantum, and specific examples of the active energy rays include ultraviolet rays and electron rays. Among the active energy rays, ultraviolet rays may be particularly preferred because of easy management.

In the curing of the coating film with active energy rays, a linear light source may be used as the light source for the active energy rays to irradiate the coating film surface with light randomly in the width direction (TD direction) and with approximately parallel strip-shaped (substantially linear) light in the flow direction (MD direction). In this operation, the tilt angle of the plate-like high refractive index regions 11 formed as the louver structure in the viewing angle control film 1 can be adjusted by adjusting the irradiation angle of the above light.

When using ultraviolet rays as the active energy rays, the irradiation condition may be preferably set such that the peak illuminance on the coating film surface is 0.1 to 50 mW/cm². Additionally or alternatively, it may be preferred to set the integrated light amount on the coating film surface to 5 to 300 mJ/cm². Additionally or alternatively, the relative moving speed of the light source for the active energy rays with respect to the above laminate may be preferably set to 0.1 to 10 m/min.

From the viewpoint of completing more reliable curing, it may also be preferred to perform irradiation with commonly-used active energy rays (active energy rays for which the process of converting the rays into strip-shaped light is not performed, scattered light) after performing the curing using the strip-shaped light as previously described. For this operation, a release sheet may be laminated on the coating film surface from the viewpoint of uniform curing.

The viewing angle control film according to the present embodiment may be a multilayered film obtained by laminating a plurality of films manufactured as above. In this multilayered film, the tilt angle of the louver structure may be different in each layer.

### 4. Method of Using Viewing Angle Control Film

The viewing angle control film according to the present embodiment can be used by providing it on the viewer's side of a display. Specifically, a pressure sensitive adhesive layer may be laminated on one surface side of the viewing angle control film and the viewing angle control film may be attached to the surface of a display on the viewer's side via the pressure sensitive adhesive layer, or the viewing angle control film may be installed on the viewer's side of a display after interposing the viewing angle control film between two transparent films, attaching the viewing angle control film to a transparent plate, or holding the viewing angle control film with a frame material.

The above pressure sensitive adhesive layer can be formed using a known pressure sensitive adhesive. For example, an acrylic-based pressure sensitive adhesive, a silicone-based pressure sensitive adhesive, or the like can be used. The thickness of the pressure sensitive adhesive layer is not particularly limited, but may be usually preferably 5 to 1,000 μm, particularly preferably 10 to 500 μm, and further preferably 15 to 100 μm.

The viewing angle control film 1 according to the present embodiment may be provided on a display so that the longitudinal direction of the louver structure extends in the horizontal direction, or may also be provided on a display so that the longitudinal direction of the louver structure extends in the vertical direction. For example, in the case of a display that is an in-vehicle display, when suppressing the reflection of light from the display on a windshield, it may be preferred to provide the display with the viewing angle control film 1 so that the longitudinal direction of the louver structure extends in the horizontal direction, or when suppressing the reflection of light from the display on a side window or when making the light/images of a display installed in front of the front passenger seat less visible to the driver, it may be preferred to provide the display with the viewing angle control film 1 so that the longitudinal direction of the louver structure extends in the vertical direction or in a desired angle direction.

It should be appreciated that the embodiments heretofore explained are described to facilitate understanding of the present invention and are not described to limit the present invention. It is therefore intended that the elements disclosed in the above embodiments include all design changes and equivalents to fall within the technical scope of the present invention.

In the present specification, unless otherwise specified, the statement of “X to Y” (X and Y are arbitrary numbers) encompasses not only the meaning of “X or more and Y or less” but also the meaning of “preferably more than X” or “preferably less than Y.” In addition, unless otherwise specified, the statement of “X or more” (X is an arbitrary number) encompasses the meaning of “preferably more than X,” and the statement of “Y or less” (Y is an arbitrary number) encompasses the meaning of “preferably less than Y.”

### EXAMPLES

Hereinafter, the present invention will be described further specifically with reference to examples etc., but the scope of the present invention is not limited to these examples etc.

### Example 1

### 1. Preparation of Light Diffusion Control Composition

Polypropylene glycol, isophorone diisocyanate, and 2-hydroxyethyl methacrylate were reacted to obtain polyether urethane methacrylate having a weight-average molecular weight of 9,900. After compounding 60 mass parts of o-phenylphenoxyethoxyethyl acrylate, 40 mass parts of the above polyether urethane methacrylate, 8 mass parts of 2-hydroxy-2-methyl-1-phenylpropan-1-one as the photopolymerization initiator, 0.5 mass parts of an acrylic-based leveling agent (available from BYK JAPAN KK, product name “BYK-361N”), and 0.08 mass parts of a benzophenone-based compound (available from BASF, product name “Tinuvin 384-2”) as the ultraviolet absorber, the compounded materials were heated and mixed under a condition of 80° C. to obtain a light diffusion control composition.

Here, the previously described weight-average molecular weight (Mw) refers to a weight-average molecular weight that is measured as a standard polystyrene equivalent value under the following condition using gel permeation chromatography (GPC) (GPC measurement).

### Measurement Condition

Measurement apparatus: HLC-8320 available from Tosoh Corporation
GPC columns (passing through in the following order): available from Tosoh Corporation
   TSK gel super H-H
   TSK gel super HM-H
   TSK gel super H2000
Solvent for measurement: tetrahydrofuran
Measurement temperature: 40° C.

### 2. Formation of Viewing Angle Control Film

One surface of a long polyethylene terephthalate film (thickness of 188 μm; first PET film; also having a role as a process sheet) was coated with the obtained light diffusion control composition to form a coating film having a thickness of about 140 μm. Then, a polyethylene terephthalate film (second PET film) having a thickness of 38 μm was laminated on the coating film, and a laminate composed of the second PET film/coating film/first PET film was thus obtained.

Subsequently, the obtained laminate was placed on a conveyor. At that time, the surface of the laminate on the second PET film side was on the upper side, and the longitudinal direction of the first PET film was made parallel to the flow direction of the conveyor. Then, an ultraviolet irradiation apparatus (available from EYE GRAPHICS CO., LTD., product name “ECS-4011GX”) having a linear high-pressure mercury lamp with a cold mirror for light concentration was installed on the conveyor on which the laminate was placed. This apparatus can irradiate an object with ultraviolet rays concentrated in a strip shape (approximately linear shape) . Upon installation of the above ultraviolet irradiation apparatus, it was installed so that the longitudinal direction of the above high-pressure mercury lamp and the flow direction of the conveyor were orthogonal to each other.

When viewed from the longitudinal direction of the high-pressure mercury lamp, the irradiation angle of the ultraviolet rays emitted from the high-pressure mercury lamp to the laminate was set to 35° with reference to the normal line to the surface of the laminate. The irradiation angle referred to herein is described as a positive value of the acute angle formed between the normal line to the surface of the laminate and the ultraviolet rays when the ultraviolet rays are emitted toward the downstream side of the flow of the conveyor with reference to the position of the laminate just below the high-pressure mercury lamp while described as a negative value of the acute angle formed between the normal line to the surface of the laminate and the ultraviolet rays when the ultraviolet rays are emitted toward the upstream side of the flow of the conveyor.

After that, while the conveyor was operated to move the above laminate at a speed of 1.0 m/min, the coating film in the laminate was cured by being irradiated with ultraviolet rays under the conditions of a peak illuminance of 2.5 mW/cm² and an integrated light amount of 40.0 mJ/cm² on the coating film surface. The above peak illuminance and integrated light amount were measured using a UV METER (available from EYE GRAPHICS CO., LTD., product name “EYE Ultraviolet Integrated Illuminance Meter UVPF-A1”) equipped with a light receiver and installed for the position of the above coating film.

Through the above process of irradiation with ultraviolet rays, a viewing angle control film was formed so that the above-described coating film was cured. Thus, a viewing angle control film laminate was obtained in which the second PET film having a thickness of 38 μm, the viewing angle control film having a thickness of 140 μm, and the first PET film having a thickness of 188 μm were laminated in this order. The thickness of the viewing angle control film was measured using a constant-pressure thickness meter (available from Takara Seisakusho, product name “Teclock PG-02J”).

When microscopic observation and the like of the cross section of the formed viewing angle control film were performed, it was confirmed that a louver structure was formed inside the viewing angle control film such that a plurality of plate-like high refractive index regions was arranged in parallel at predetermined intervals and bent in the film thickness direction. The average angle on the acute angle side between the main surfaces of the louver structure and the normal line to the viewing angle control film was 35°.

### Example 2

After compounding 60 mass parts of o-phenylphenoxyethoxyethyl acrylate, 40 mass parts of the polyether urethane methacrylate obtained in the same manner as in Example 1, 8 mass parts of 2-hydroxy-2-methyl-1-phenylpropan-1-one as the photopolymerization initiator, 0.5 mass parts of an acrylic-based leveling agent (available from BYK JAPAN KK, product name “BYK-361N”), and 1.0 mass parts of a weakly basic hindered amine-based compound (base dissociation constant pKb: 11.3) represented by the following structural formula (B) and having a carbonate skeleton, the compounded materials were heated and mixed under a condition of 80° C. to obtain a light diffusion control composition.

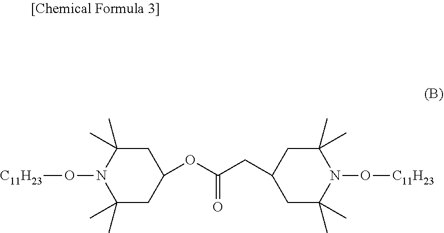

A viewing angle control film laminate was manufactured in the same manner as in Example 1 except that the above light diffusion control composition was used, the thickness of the coating film was 130 μm, and the irradiation angle of the ultraviolet rays was 40°. The thickness of the viewing angle control film formed was 130 μm.

When microscopic observation and the like of the cross section of the formed viewing angle control film were performed, it was confirmed that a louver structure was formed inside the viewing angle control film such that a plurality of plate-like high refractive index regions was arranged in parallel at predetermined intervals. The angle on the acute angle side between the main surfaces of the louver structure and the normal line to the viewing angle control film was 40°.

### Example 3

A light diffusion control composition was prepared in the same manner as in Example 1 except that no ultraviolet absorber was compounded. One surface of a long polyethylene terephthalate film (thickness of 188 μm; first PET film; also having a role as a process sheet) was coated with the obtained light diffusion control composition to form a coating film having a thickness of about 160 μm. A laminate composed of the coating film and the first PET film was thus obtained.

Subsequently, the obtained laminate was placed on a conveyor. At that time, the surface of the laminate on the coating film side was on the upper side, and the longitudinal direction of the first PET film was made parallel to the flow direction of the conveyor. Then, the laminate placed on the conveyor was irradiated with ultraviolet rays concentrated in a strip shape (approximately linear shape) in the same manner as in Example 1. The irradiation angle of the ultraviolet rays emitted from the high-pressure mercury lamp to the laminate was set to 55° with reference to the normal line to the surface of the laminate.

After that, while the conveyor was operated to move the above laminate at a speed of 1.0 m/min, the coating film in the laminate was cured by being irradiated with ultraviolet rays under the conditions of a peak illuminance of 2.5 mW/cm² and an integrated light amount of 40.0 mJ/cm² on the coating film surface (this curing may be referred to as “primary curing” for convenience).

Subsequently, after a polyethylene terephthalate film (second PET film) having a thickness of 38 μm was laminated on the surface of the laminate on the coating film side, the coating film in the laminate was cured by being irradiated through the film with ultra violet rays (scattered light) under the conditions of a peak illuminance of 190 mW/cm² and an integrated light amount of 180 mJ/cm² (this curing may be referred to as “secondary curing” for convenience).

Through the above primary curing and secondary curing, a viewing angle control film was formed so that the above-described coating film was cured. Thus, a viewing angle control film laminate was obtained in which the second PET film having a thickness of 38 μm, the viewing angle control film having a thickness of 160 μm, and the first PET film having a thickness of 188 μm were laminated in this order.

When microscopic observation and the like of the cross section of the formed viewing angle control film were performed, it was confirmed that a louver structure was formed inside the viewing angle control film such that a plurality of plate-like high refractive index regions was arranged in parallel at predetermined intervals. The angle on the acute angle side between the main surfaces of the louver structure and the normal line to the viewing angle control film was 55°.

### Example 4

A light diffusion control composition was prepared in the same manner as in Example 1 except that no ultraviolet absorber was compounded. One surface of a long polyethylene terephthalate film (thickness of 188 μm; first PET film; also having a role as a process sheet) was coated with the obtained light diffusion control composition to form a coating film having a thickness of about 240 μm. A laminate composed of the coating film and the first PET film was thus obtained.

Subsequently, the obtained laminate was placed on a conveyor. At that time, the surface of the laminate on the coating film side was on the upper side, and the longitudinal direction of the first PET film was made parallel to the flow direction of the conveyor. Then, the laminate placed on the conveyor was irradiated with ultraviolet rays concentrated in a strip shape (approximately linear shape) in the same manner as in Example 1. The irradiation angle of the ultraviolet rays emitted from the high-pressure mercury lamp to the laminate was set to 55° with reference to the normal line to the surface of the laminate.

After that, while the conveyor was operated to move the above laminate at a speed of 1.0 m/min, the coating film in the laminate was cured by being irradiated with ultraviolet rays under the conditions of a peak illuminance of 2.5 mW/cm² and an integrated light amount of 40.0 mJ/cm² on the coating film surface (primary curing).

Subsequently, a polyethylene terephthalate film (second PET film) having a thickness of 38 μm was laminated on the surface of the laminate on the coating film side. Then, the ultraviolet irradiation apparatus used in the primary curing was also used to irradiate the coating film of the above laminate with ultraviolet rays concentrated in a strip shape (approximately linear shape) through the second PET film under the conditions of a peak illuminance of 2.5 mW/cm² and an integrated light amount of 40.0 mJ/cm² to cure the coating film (secondary curing). In this operation, the irradiation angle of the ultraviolet rays emitted from the high-pressure mercury lamp to the laminate was set to 27° with reference to the normal line to the surface of the laminate.

Through the above primary curing and secondary curing, a viewing angle control film was formed so that the above-described coating film was cured. Thus, a viewing angle control film laminate was obtained in which the second PET film having a thickness of 38 μm, the viewing angle control film having a thickness of 240 μm, and the first PET film having a thickness of 188 μm were laminated in this order.

When microscopic observation and the like of the cross section of the formed viewing angle control film were performed, it was confirmed that a louver structure was formed inside the viewing angle control film such that a plurality of plate-like high refractive index regions was arranged in parallel at predetermined intervals to have different angles in the film thickness direction. The angle on the acute angle side between one main surfaces of the louver structure (on the first PET film side) and the normal line to the viewing angle control film was 55°, and the angle on the acute angle side between the other main surfaces of the louver structure (on the second PET film side) and the normal line to the viewing angle control film was 27°.

### Example 5

A light diffusion control composition was prepared in the same manner as in Example 1 except that no ultraviolet absorber was compounded. A first viewing angle control film laminate was manufactured in the same manner as in Example 3 except that the light diffusion control composition was used, the thickness of the coating film was about 130 μm, and the irradiation angle of the ultraviolet rays was 40°. The thickness of the viewing angle control film (first viewing angle control film) in the first viewing angle control film laminate was 130 μm.

When microscopic observation and the like of the cross section of the first viewing angle control film were performed, it was confirmed that a louver structure was formed inside the viewing angle control film such that a plurality of plate-like high refractive index regions was arranged in parallel at predetermined intervals. The angle on the acute angle side between the main surfaces of the louver structure and the normal line to the viewing angle control film was 40°.

A viewing angle control film laminate obtained in the same manner as in Example 3 was used as a second viewing angle control film laminate, and a viewing angle control film (second viewing angle control film) in the second viewing angle control film laminate was laminated on the first viewing angle control film in the above first viewing angle control film laminate. Specifically, a second PET film of the second viewing angle control film laminate was removed, a first PET film of the first viewing angle control film laminate was removed, and the exposed second viewing angle control film and the exposed first viewing angle control film were laminated. Thus, a laminate composed of the second PET film/first viewing angle control film (louver angle 40°, thickness 130 μm)/second viewing angle control film (louver angle 55°, thickness 160 μm)/first PET film was obtained.

### Example 6

A light diffusion control composition was prepared in the same manner as in Example 1 except that no ultraviolet absorber was compounded. A viewing angle control film laminate was manufactured in the same manner as in Example 1 except that the light diffusion control composition was used, the thickness of the coating film was about 100 μm, and the irradiation angle of the ultraviolet rays was 25°. The thickness of the viewing angle control film was 100 μm.

When microscopic observation and the like of the cross section of the formed viewing angle control film were performed, it was confirmed that a louver structure was formed inside the viewing angle control film such that a plurality of plate-like high refractive index regions was arranged in parallel at predetermined intervals. The angle on the acute angle side between the main surfaces of the louver structure and the normal line to the viewing angle control film was 25°.

### Comparative Example 1

“Security/Privacy Filter PF12.1W H2” (thickness: 536 μm) available from 3M Company was used as a viewing angle control film of Comparative Example 1.

### <Testing Example 1> (Measurement of Incident Light Diffusion Angle Region)

For each of the viewing angle control film laminates of Examples and the viewing angle control film of Comparative Example, an incident light diffusion angle region in which the haze value would be 80% or more was measured using a variable haze meter (available from MURAKAMI COLOR RESEARCH LABORATORY, product name “HM-150N”).

Specifically, each of the viewing angle control film laminates and the viewing angle control film (both may be collectively referred to as a “viewing angle control film” for convenience, hereinafter) was installed so that the distance from the integrating sphere aperture in the above variable haze meter to the arrival position of the measurement light would be 62 mm. At that time, the viewing angle control film laminate was installed so that the first PET film side would be located on the measurement light source side. Then, a change in the haze value (%) was measured by rotating the longitudinal direction of the viewing angle control film (carrying direction when manufacturing it) with the width direction of the viewing angle control film at the above arrival position as a rotation axis. That is, only the tilt angle of the viewing angle control film was changed thereby to vary the incident angle of the measurement light with respect to the viewing angle control film, and the haze value (%) was measured at each incident angle. Provided that the incident angle of the measurement light in the normal direction of the viewing angle control film was 0° and the direction of rotation in which the traveling direction side in the longitudinal direction of the viewing angle control film (carrying direction when manufacturing it) approached the light source gave a positive angle, the measurement was performed in a range of −60° to 60°. Details of the measurement condition were as follows.
Light source: C light source
Measuring diameter: φ18 mm
Diameter of integrating sphere aperture: φ25.4 mm

Then, the angle range (defined by the start angle and the end angle) in which the measured haze value (%) was 80% or more was specified as the incident light diffusion angle region. In addition, the central angle of the incident light diffusion angle region was calculated from the above angle range. The results are listed in Table 1.

### <Testing Example 2> (Measurement of Total Luminous Transmittance)

For each of the viewing angle control film laminates of Examples and the viewing angle control film of Comparative Example, the total luminous transmittance (%) was measured in accordance with JIS K7361-1: 1997 by using a haze meter (available from NIPPON DENSHOKU INDUSTRIES CO., LTD., product name “SH-7000”) installed at the front face 0° of the viewing angle control film. The results are listed in Table 1.

### <Testing Example 3> (Measurement of Haze Value)

For each of the viewing angle control film laminates of Examples and the viewing angle control film of Comparative Example, the haze value (%) was measured in accordance with JIS K7136: 2000 by using a haze meter (available from NIPPON DENSHOKU INDUSTRIES CO., LTD., product name “SH-7000”) installed at the front face 0° of the viewing angle control film. The results are listed in Table 1.

### <Testing Example 4> (Measurement of Image Clarity)

For each of the viewing angle control film laminates of Examples and the viewing angle control film of Comparative Example, the image clarity (%) was measured for five types of optical combs (comb width: 0.125 mm, 0.25 mm, 0.5 mm, 1.0 mm, and 2.0 mm) in accordance with the transmission method of JIS K7374: 2007 by using an image clarity meter (available from Suga Test Instruments Co., Ltd., product name “ICM-1T”) and the total value thereof (sum of image clarity values) was calculated. The results are listed in Table 1.

### <Testing Example 5> (Measurement of Luminance Change Rate)

A white screen was displayed on the screen of a smartphone (available from SAMSUNG, product name “GALAXY S6”). A luminance meter (available from KONICA MINOLTA, INC., product name “Imaging luminance meter ProMetric-I16+ Conoscope”) was installed at a position 3 mm away from the display surface of the smartphone, the position being a position of the front face 0° with respect to the center of the display, to measure a luminance (cd/m²), and the luminance was defined as L0.

Then, each of the viewing angle control film laminates of Examples and the viewing angle control film of Comparative Example was installed so as to be in close contact with the display of the above smartphone. At that time, the viewing angle control film laminate was installed so that the first PET film side was arranged on the display surface side of the smartphone. Then, the luminance (cd/m²) was measured in the same manner as above, and the luminance was defined as L1. From the obtained luminance L0 and luminance L1, the luminance change rate (%) at the front face 0° was calculated based on the following formula (1). The results are listed in Table 2.

Luminance change rate (%)=(L1/L0)×100 (1)

In addition, the above luminance meter was installed at a position 3 mm away from the display surface of the above smartphone, the position being a position of −10° (a positive angle was defined in a direction of rotation in which a traveling direction side in the longitudinal direction of the viewing angle control film (carrying direction when manufacturing it) approached the light source) from the central angle of the incident light diffusion angle region of the viewing angle control film with reference to the center of the display. Then, the luminance L0 with no viewing angle control film and the luminance L1 with the viewing angle control film were measured in the same manner as in the case of the above front face 0°, and the luminance change rate (%) at −10° from the central angle was calculated based on the above formula (1). The results are listed in Table 2.

### <Testing Example 6> (Visual Evaluation)

A menu screen was displayed on the screen of a commercially available smartphone (available from SAMSUNG, product name “GALAXY S6”). Then, each of the viewing angle control film laminates of Examples and the viewing angle control film of Comparative Example was installed so as to be in close contact with the display of the above smartphone. At that time, the viewing angle control film laminate was installed so that the first PET film side was arranged on the display surface side of the smartphone. Then, the screen was viewed from a position of about 30 cm from the display of the above smartphone, and the degree of image blur and the brightness of the screen when viewed from the front were determined and evaluated based on the following criteria. In addition, the brightness of the screen when viewed from the central angle −10° of the incident light diffusion angle region was determined, provided that a positive angle was defined in a traveling direction of the viewing angle control film in its longitudinal direction (carrying direction when manufacturing it) with reference to the center of the display, and the viewing angle control was evaluated based on the following criteria. If the screen is bright when viewed from the front and dark when viewed from an oblique angle, it can be said that the viewing angle is controlled. Respective results are listed in Table 2.

### Evaluation Criteria for Image Blur

A . . . Image blur was not visually recognized.
B . . . Image blur was slightly visually recognized, but it was not at a problematic level.
C . . . Image blur was visually recognized, but the content of the image was at a perceivable level.
D . . . Image blur was visually recognized, and the content of the image was at an unperceivable level.

### Evaluation Criteria for Front Brightness

A . . . Screen was sufficiently bright.
B . . . Screen was not sufficiently bright, but brightness was at a non-problematic level.
C . . . Screen was dark.
D . . . Screen was too dark and problematic to visually recognize it.

### Evaluation Criteria for Viewing Angle Control

A . . . Screen was completely black, and the content of the image was visually unrecognizable at all.
B . . . Screen was dark, and the content of the image was visually unrecognizable.
C . . . Screen was somewhat bright, but the content of the image was difficult to visually recognize.
D . . . Screen was bright, and the content of the image was visually recognizable.

In addition, a green image was entirely displayed on the display of a smartphone (available from SAMSUNG, product name “GALAXY S6”). Then, each of the viewing angle control film laminates of Examples and the viewing angle control film of Comparative Example was installed so as to be in close contact with the display of the above smartphone. At that time, the viewing angle control film laminate was installed so that the first PET film side was arranged on the display surface side of the smartphone. Then, the display image was viewed from a position of about 30 cm from the display of the above smartphone, and the degree of glare was determined and evaluated based on the following criteria. The results are listed in Table 2.

### Evaluation Criteria for Glare

A . . . Glare was not confirmed at all.
B . . . Glare was slightly confirmed, but it was at a non-problematic level.
C . . . Glare was weakly confirmed.
D . . . Glare was confirmed on the entire surface.

### <Testing Example 7> (Evaluation of Weather Resistance)

The viewing angle control film of Comparative Example was interposed between the first PET film and the second PET film used in Examples, and this was used as a viewing angle control film laminate. An acrylic-based pressure sensitive adhesive layer (no ultraviolet absorber, thickness 25 μm) was laminated on the first PET film in the viewing angle control film laminate of each of Examples and Comparative Example.

Then, an acrylic-based pressure sensitive adhesive layer (thickness 20 μm) containing an ultraviolet absorber was laminated on one surface of a first polyvinyl chloride resin (PVC) film (containing an ultraviolet absorbent, thickness 80 μm).

In addition, an aluminum layer (nano-order thickness) was vapor-deposited as a reflective layer on one surface of a second PVC film (no ultraviolet absorber, thickness 50 μm). Then, an acrylic-based pressure sensitive adhesive layer (no ultraviolet absorber, thickness 25 μm) was laminated on the surface of the PVC film opposite to the reflective layer.

Furthermore, an acrylic-based pressure sensitive adhesive layer (thickness 20 μm) containing an ultraviolet absorber was laminated on one surface of a fluorine-based resin film (containing an ultraviolet absorbent, thickness 100 μm).

The above constitutional bodies were laminated to obtain a laminate composed of the fluorine-based resin film, the acrylic-based pressure sensitive adhesive layer containing an ultraviolet absorber, the first PVC film, the acrylic-based pressure sensitive adhesive layer containing an ultraviolet absorber, the second PET film, the viewing angle control film, the first PET film, the acrylic-based pressure sensitive adhesive layer, the reflective layer, the second PVC film, and the acrylic-based pressure sensitive adhesive layer in this order from the top.

The laminate thus obtained was irradiated with ultraviolet rays for 3,000 hours (irradiance: 78.5 W/m²) under an atmosphere of a temperature of 63±3° C. (black panel temperature) and 50% RH in accordance with JIS A1439: 2016 using a sunshine weather-ometer (SWOM) (available from Suga Test Instruments Co., Ltd., product name “S80”). Subsequently, the laminate was disassembled and the liquefaction of the viewing angle control film was examined. Then, the liquefaction suppression (weather resistance) was evaluated based on the following evaluation criteria. The results are listed in Table 2.

### Evaluation Criteria for Weather Resistance

A . . . Liquefaction did not occur at all.
B . . . When the exposed surface of the viewing angle control film peeled off from the PET films was touched with a finger, a slight stickiness was observed, but no fingerprints remained on the exposed surface after touching.
C . . . When the exposed surface of the viewing angle control film peeled off from the PET films was touched with a finger, a slight stickiness was observed, and fingerprints remained on the exposed surface after touching.
D . . . Liquefaction occurred in whole.

TABLE 1

| | Incident light | | | | | |
|---|---|---|---|---|---|---|
| | diffusion angle region | | | Total | | Image |
| | Start | End | Central | luminous | Haze | clarity |
| | angle | angle | angle | transmittance | value | (Total |
| | [deg.] | [deg.] | [deg.] | [%] | [%] | value) |
| Example 1 | −60.0 | −21.3 | −40.6 | 90.8 | 4.5 | 472.2 |
| Example 2 | −60.0 | −25.6 | −42.8 | 90.9 | 4.1 | 472.4 |
| Example 3 | −60.0 | −39.6 | −49.8 | 90.9 | 2.8 | 473.0 |
| Example 4 | −60.0 | −11.7 | −35.8 | 90.6 | 12.0 | 443.4 |
| Example 5 | −60.0 | −24.2 | −42.1 | 90.4 | 6.0 | 440.8 |
| Example 6 | −60.0 | −11.3 | −35.7 | 90.8 | 7.0 | 473.8 |
| Comparative | −60.0 | −2.1 | −31.0 | 83.0 | 6.7 | 175.7 |
| Example 1 | | | | | | |

TABLE 2

| | Luminance change rage (%) | | Visual evaluation | | | | Evaluation |
|---|---|---|---|---|---|---|---|
| | Front face | Central angle | Image | Front | Viewing angle | | of weather |
| | 0° | −10° | blur | brightness | control | Glare | resistance |
| Example 1 | 100.0 | 71.5 | A | A | B | B | B |
| Example 2 | 98.8 | 74.2 | A | B | B | B | A |
| Example 3 | 100.0 | 93.4 | A | A | C | A | C |
| Example 4 | 97.8 | 86.7 | B | B | B | B | C |
| Example 5 | 97.4 | 70.3 | C | B | B | B | C |
| Example 6 | 97.6 | 89.0 | A | B | C | B | C |
| Comparative | 81.5 | 5.4 | D | D | A | D | A |
| Example 1 | | | | | | | |

As found from Table 2, according to the viewing angle control films manufactured in Examples, the viewing angle was able to be controlled while suppressing the deterioration in the front face luminance of the display. Moreover, there was no problem also in the display performance of the display. Furthermore, the viewing angle control films manufactured in Examples 1 and 2 were also excellent in the weather resistance.

### INDUSTRIAL APPLICABILITY

The viewing angle control film of the present invention is suitable, for example, as a viewing angle control film provided in an in-vehicle display for safety.

### DESCRIPTION OF REFERENCE NUMERALS

1 . . . viewing angle control film
11 . . . Plate-like high refractive index region
12 . . . Low refractive index region

1. A viewing angle control film having an incident light diffusion angle region, wherein
when the viewing angle control film is installed vertically to a ground surface, the incident light diffusion angle region in an up-down direction does not include a front face 0° in a horizontal direction with respect to the ground surface, and
a total luminous transmittance at the front face 0° is 85% or more and 100% or less.

2. The viewing angle control film according to claim 1, wherein a haze value at the front face 0° is 0% or more and 40% or less.

3. The viewing angle control film according to claim 1, wherein a sum of image clarity values of 0.125 mm, 0.25 mm, 0.5 mm, 1.0 mm, and 2.0 mm optical combs measured in accordance with JIS K7374: 2007 is 350 or more.

4. The viewing angle control film according to claim 1, wherein the viewing angle control film has a thickness of 50 μm or more and 450 μm or less.

5. The viewing angle control film according to claim 1, wherein, provided that L0 represents a luminance measured when the viewing angle control film is not present between a given light source and a luminance measuring device and L1 represents a luminance measured when the viewing angle control film is present between the light source and the luminance measuring device, a luminance change rate (%) represented by Formula (1) below is:
85% or more at the front face 0° of the viewing angle control film; and
95% or less at −10° (a positive angle is defined in a direction of rotation in which a traveling direction side in a carrying direction when manufacturing the viewing angle control film approaches the light source) from a central angle of the incident light diffusion angle region of the viewing angle control film;
wherein:
Luminance change rate (%)=(L1/L0)×100 (1).

6. The viewing angle control film according to claim 1, wherein
the viewing angle control film has a louver-shaped internal structure comprising a plurality of regions having a relatively high refractive index in a region having a relatively low refractive index, and
the louver-shaped internal structure is provided so that a longitudinal direction of the louver-shaped internal structure extends horizontally when the viewing angle control film is installed vertically to the ground surface.
